(19) United States
(12) Patent Application Publication
(10) Pub. No.: US 2024/0388241 A1
(43) Pub. Date: Nov. 21, 2024

(54) SOLAR CHARGING APPARATUS AND DOORBELL DEVICE

(71) Applicant: JINHONG WU, Shenzhen (CN)

(72) Inventors: JINHONG WU, Shenzhen (CN); YAO XIAO, Shenzhen (CN)

(21) Appl. No.: 18/396,945

(22) Filed: Dec. 27, 2023

(30) Foreign Application Priority Data
May 17, 2023 (CN) 202321190957.8

(51) Int. Cl. H02J 7/35; G08B 3/10; H02J 7/00; H02S 20/32

(52) U.S. Cl. CPC H02S 20/30; H02S 20/22; G08B 3/10

(57) ABSTRACT

The present disclosure provides a solar charging apparatus and a doorbell device. The solar charging apparatus is configured for the doorbell device, and includes a base configured for mounting and fixing a doorbell; a solar panel assembly; and an adjustment structure, wherein: the solar panel is rotatably connected to the base by the adjustment structure, the solar panel assembly comprises a first solar panel configured for converting solar energy into electrical energy which is supplied to the doorbell, and the adjustment structure is configured for adjusting an angle of the first solar panel relative to the base, so as to switch the solar charging apparatus between a folded state and an unfolded state.

### CROSS-REFERENCE TO RELATED APPLICATIONS

This application claims the benefit of priority to Chinese Patent Application Number 202321190957.8 filed on May 17, 2023, in the China National Intellectual Property Administration. The entire contents of the above-identified application are hereby incorporated by reference.

### TECHNICAL FIELD

The disclosure relates to the technical field of doorbell, and in particular to a solar charging apparatus and doorbell device.

### BACKGROUND

A traditional doorbell with a solar charging function comprises a solar panel, a charging base and a charging connecting line. The solar panel is fixed on the charging base, and the solar panel and the charging base are combined into an integral non-separable element. However, when the direction and the intensity of the sun change throughout the year, because the solar panel is arranged at a set angle and at a set location, the solar panel may not be at an optimal working angle during the four seasons of the year. Moreover, because the area of the solar panel may be limited by the charging base, the light conversion efficiency may be low, therefore, the charging power may be severely limited, resulting insufficient power supply to the doorbell.

### SUMMARY OF DISCLOSURE

The present disclosure provides a solar charging apparatus fixed with a doorbell and capable of controlling a solar panel to rotate to an optimal angle. Therefore, the solar panel can adjust to an optimal irradiation angle according to the sun orientation at different times and different seasons, thereby improving the light conversion efficiency and improving the charging efficiency.

In addition, the present disclosure provides a doorbell device with the solar charging apparatus described above.

The present disclosure provides a solar charging apparatus configured for a doorbell device comprising: a base configured for mounting and fixing a doorbell; a solar panel assembly; and an adjustment structure, wherein: the solar panel is rotatably connected to the base by the adjustment structure, the solar panel assembly comprises a first solar panel configured for converting solar energy into electrical energy which is supplied to the doorbell, and the adjustment structure is configured for adjusting an angle of the first solar panel relative to the base, so as to switch the solar charging apparatus between a folded state and an unfolded state.

In some embodiments, the adjustment structure comprises a connecting member and a matching member, the matching member is rotatably connected to the connecting member, one of the connecting member and the matching member is disposed on the base, and another one of the connecting member and the matching member is disposed on the solar panel assembly.

In some embodiments, one of the connecting member and the matching member comprises a connecting portion, another one of the connecting member and the matching member comprises an accommodation portion, and the connecting portion is rotatably accommodated in the accommodation portion, the matching member is rotatably connected to the connecting member via the accommodation portion and the connecting portion.

In some embodiments, the connecting portion comprises a shaft arranged at one end of the connecting member along a width direction of the connecting member, a shape of the accommodation portion matches a shape of the shaft, and the shaft is rotatably accommodated in the accommodation portion.

In some embodiments, comprising a plurality of ribs spaced from each other and arranged on a circumferential wall of the shaft, the plurality of rib extending along an extending direction of the shaft; and a plurality of concaves spaced from each other and arranged on an inner wall of the accommodation portion, wherein each of the plurality of ribs is respectively engaged with a corresponding one of the plurality of concaves, so that the matching member is rotatably connected to the connecting member and positioned above the connecting member.

In some embodiments, the connecting portion comprises a spherical shape, and a shape of the accommodation portion matches a contour of the connecting portion, so that the connecting portion is rotatably received in the accommodation portion.

In some embodiments, the matching member comprises: a claw arranged on the solar panel assembly, the accommodation portion is defined in the claw; and a fixing member sleeved on the claw and configured for fixedly accommodating the connecting portion in the accommodation portion.

In some embodiments, the connecting member is arranged on the base, the adjustment structure comprises a pivot element, the pivot element comprises a first end and a second end arranged opposite to the first end, the first end is rotatably connected to the matching member, and the second end is rotatably connected to the connecting member, so that the connecting member is rotatably connected to the matching member by the pivot element.

In some embodiments, an end of the connecting member away from the base is provided with a through-hole, the pivot element comprises an extension portion, the extension portion protrudes from a surface of the second end facing the connecting member and is inserted into the through-hole, so that the connecting member is rotatably engaged with the connecting member.

In some embodiments, the connecting member comprises a first connecting member, a second connecting member and a sliding member, one end of the first connecting member is arranged on the base, and another end of the first connecting member is slidably connected to the second connecting member by the sliding member.

In some embodiments, the connecting member and the base are integrally formed.

In some embodiments, the connecting member is arranged on the base, the solar charging apparatus further comprising an abutting portion on an end of the connecting member away from the base or on a back surface of the solar panel assembly, and the abutting portion is configured for setting a position of the solar panel assembly relative to the connecting member so that, when the solar charging apparatus is in the folded state, the first solar panel is flushed with the base.

In some embodiments, the solar panel assembly further comprises a mounting member, the mounting member comprises a first surface and a second surface arranged opposite to the first surface, the first surface is configured for mounting the first solar panel, and the second surface is configured for mounting the adjustment structure.

In some embodiments, the first surface of the mounting member defines a receiving groove, and the first solar panel is fixedly received in the receiving groove.

In some embodiments, the base comprises a first mounting area configured for mounting the doorbell.

In some embodiments, the base further comprises at least a second mounting area disposed adjacent the first mounting area, the solar charging apparatus further comprises at least one second solar panel mounted on the at least one second mounting area.

In some embodiments, the at least one second mounting area is arranged obliquely to the first mounting area.

In some embodiments, further comprising a cover arranged on the base, the cover and the base forming an accommodating cavity configured for accommodating the doorbell.

The present disclosure further provides a solar charging apparatus configured for a doorbell device, comprising: a base configured for mounting and fixing a doorbell; a solar panel; and an adjustment structure, wherein: the solar panel is connected to the base by the adjustment structure, the solar panel is configured for converting solar energy into electrical energy which is supplied to the doorbell, and the adjustment structure is connected between the base and the solar panel and configured for adjusting an angle of the solar panel relative to the base.

The present disclosure further provides a doorbell device comprising: a doorbell; a base configured for mounting and fixing the doorbell; a solar panel assembly; and an adjustment structure, wherein: the solar panel assembly is rotatably connected to the base by the adjustment structure, the solar panel assembly comprises a solar panel configured for converting solar energy into electrical energy which is supplied to the doorbell; and the adjustment structure is configured for adjusting an angle of the solar panel relative to the base, so as to switch the solar panel assembly between a folded state and an unfolded state.

According to the solar charging apparatus provided by the present disclosure, the solar charging apparatus is capable of controlling a solar panel to rotate to an optimal angle. Therefore, the solar panel can adjust to an optimal irradiation angle according to the sun orientation at different times and different seasons, thereby improving the light conversion efficiency and improving the charging efficiency. Ultimately, it keeps the solar charging apparatus in optimal working condition. In addition, the solar panel is close to the doorbell, and is convenient for wiping dust on the solar panel.

### BRIEF DESCRIPTION OF DRAWINGS

The drawings illustrate the embodiments and form a part of the specification, together with a written description of the specification, to explain the exemplary embodiment of the embodiment. It is obvious that the drawings in the following description are only some embodiments of the present disclosure. For ordinary technical personnel in the art, other drawings can be obtained based on these drawings without any creative labor. In all drawings, the same reference numerals refer to similar but not necessarily identical elements.

FIG. 1 is a three-dimensional structure diagram illustrating a solar charging apparatus of a doorbell device according to a first embodiment of the present disclosure.

FIG. 2 is an exploded schematic diagram illustrating the solar charging apparatus shown in FIG. 1.

FIG. 3 is an exploded schematic diagram illustrating the solar charging apparatus shown in FIG. 1, but viewed from another angle.

FIG. 4 is a three-dimensional structure diagram illustrating a mounting member shown in FIG. 1.

FIG. 5 is a three-dimensional structure diagram illustrating the doorbell device in a first unfolded state according to the first embodiment of the present disclosure.

FIG. 6 is a three-dimensional structure diagram illustrating the doorbell device in a second unfolded state according to the first embodiment of the present disclosure.

FIG. 7 is a three-dimensional structure diagram illustrating the doorbell device in a folded state according to the first embodiment of the present disclosure.

FIG. 8 is a three-dimensional structure diagram illustrating the doorbell device according to a second embodiment of the present disclosure.

FIG. 9 is an exploded schematic diagram illustrating the solar charging apparatus shown in FIG. 8.

FIG. 10 is a three-dimensional structure diagram illustrating the doorbell device according to a third embodiment of the present disclosure.

FIG. 11 is an exploded schematic diagram illustrating the solar charging apparatus shown in FIG. 10.

FIG. 12 is a three-dimensional structure diagram illustrating the doorbell device according to a fourth embodiment of the present disclosure.

FIG. 13 is an exploded schematic diagram illustrating the solar charging apparatus shown in FIG. 12.

FIG. 14 is enlarged diagram of a portion labeled XIV shown in FIG. 13.

FIG. 15 is a three-dimensional structure diagram illustrating the doorbell device according to a fifth embodiment of the present disclosure.

FIG. 16 is an exploded schematic diagram illustrating the solar charging apparatus shown in FIG. 15.

FIG. 17 is enlarged diagram of a portion labeled XVII shown in FIG. 16.

FIG. 18 is an exploded schematic diagram illustrating the solar charging apparatus according to a sixth embodiment of the present disclosure.

FIG. 19 is a three-dimensional structure diagram illustrating the doorbell device according to a seventh embodiment of the present disclosure.

FIG. 20 is a three-dimensional structure diagram illustrating the doorbell device according to an eighth embodiment of the present disclosure.

FIG. 21 is an exploded schematic diagram illustrating the solar charging apparatus shown in FIG. 20.

FIG. 22 is another exploded schematic diagram illustrating the solar charging apparatus shown in FIG. 20.

### DETAILED DESCRIPTION

In order to make the purpose, technical solution, and advantages of this utility model clearer, further detailed descriptions will be given below in conjunction with the accompanying drawings. Obviously, the described implementation methods are only a part of the implementation methods of this utility model, not all of them. Based on the implementation methods in this utility model, all other implementation methods obtained by ordinary technical personnel in this field without creative labor fall within the scope of protection of this utility model.

The present disclosure provides a doorbell device comprising a solar charging apparatus and a doorbell arranged on the solar charging apparatus, the solar charging apparatus is configured for converting solar energy to electric energy and supply to the doorbell.

In the present disclosure, the doorbell detachably engages with the solar charging apparatus. More specifically, the doorbell can be engaged with the solar charging apparatus by threaded connection, insertion, clamping, adhesive, etc. The doorbell may adopt an existing doorbell, which will not be described in detail here.

In the present disclosure, the solar charging apparatus includes a base, a rotatable solar panel and an adjustment structure, the adjustment structure is connected between the base and the solar panel and configured for adjusting an angle of the solar panel relative to the base. The rotatable solar panel has at least one rotation mode of left and right rotation, up and down rotation and 360 degrees rotation relative to the base of the solar charging apparatus. In this way, the user can control the solar panel to rotate an optimal angle according to the orientation of the season, the orientation of the house and the user's experience. As a result, the solar panel remains in an optimal orientation, so as to receive sunlight to the maximum extent possible and improve light conversion efficiency.

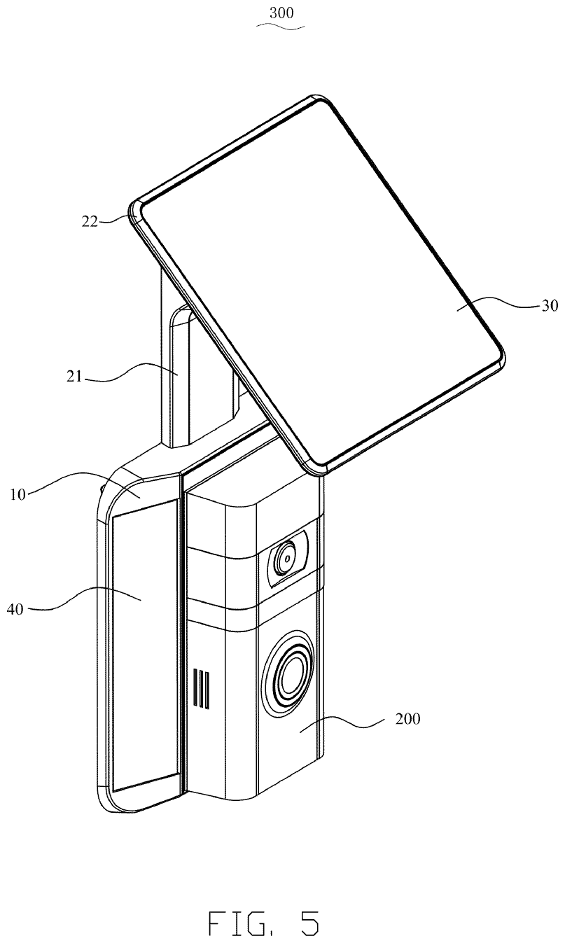

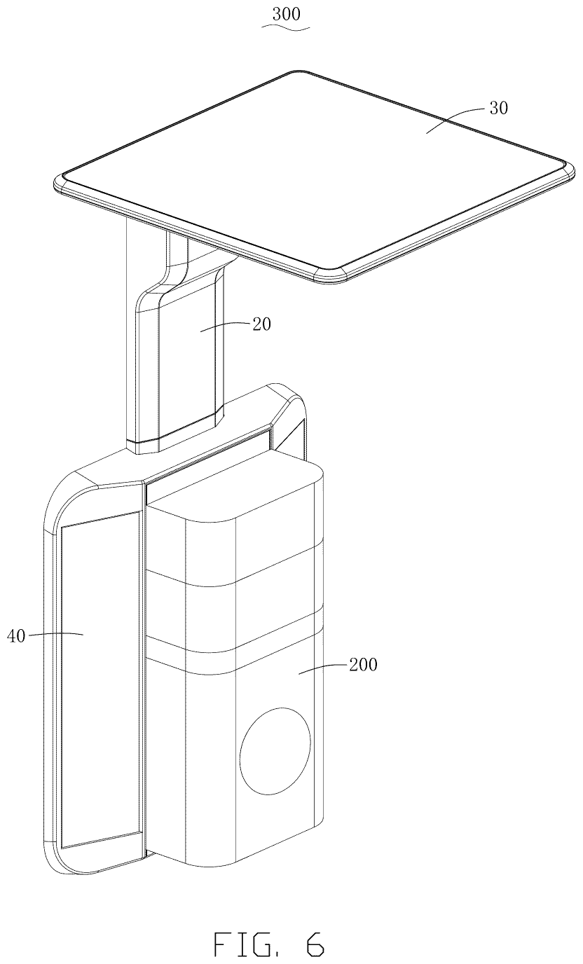

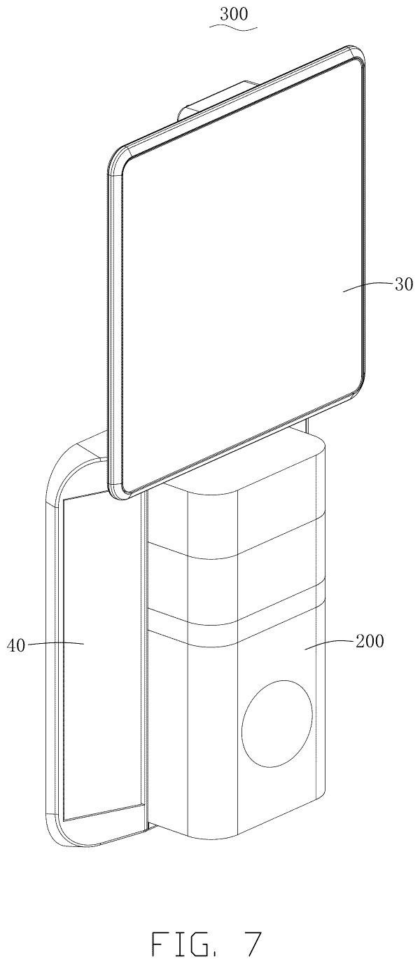

In the present disclosure, the solar panel of the solar charging apparatus can rotate relative to the base of the solar charging apparatus, therefore, the solar charging apparatus can switch between an unfolded state (as shown in FIG. 5 and FIG. 6) and a folded state (as shown in FIG. 7). In the folded state, the solar panel of the solar charging apparatus is substantially flushed with the base of the solar charging apparatus, therefore, a volume occupied by the solar charging apparatus can be minimized, and it is easier to package and transport.

### First Embodiment

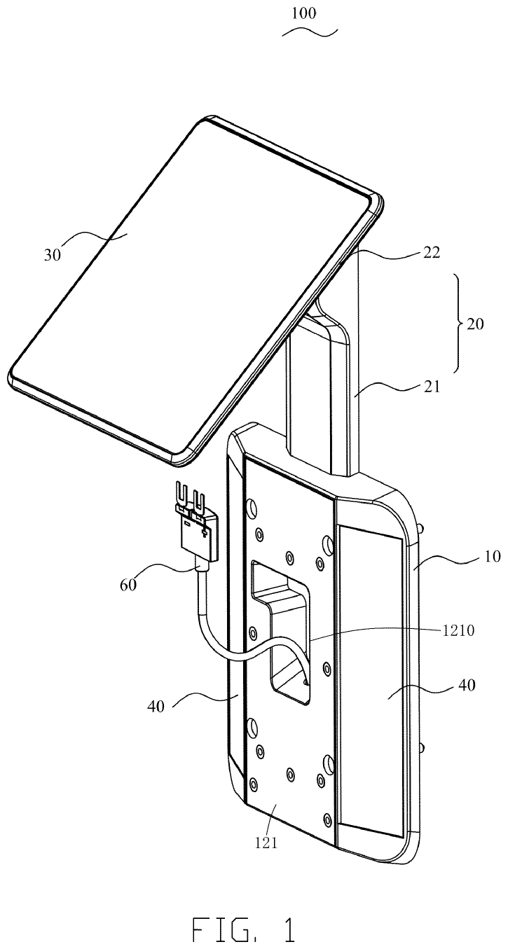

Referring to FIGS. 1 to 5, a doorbell device 300 in accordance with this embodiment is shown. The doorbell device 300 comprises a solar charging apparatus 100 and a doorbell 200. In this embodiment, the doorbell 200 is arranged on the solar charging apparatus 100 by adhesive or/and a fastener (not shown) such as a screw and a pin, and the solar charging apparatus 100 is configured for converting solar energy to electric energy and supply to the doorbell 200.

In this embodiment, the solar charging apparatus 100 includes a base 10, a solar panel assembly 30, an adjustment structure 20, a circuit board 50 and an electric connector 60. The solar panel assembly 30 is rotatably connected to the base 10 by the adjustment structure 20, and the circuit board 50 and the electric connector 60 are received in the base 10, the circuit board 50 is electrically connected to the doorbell 200 by the electric connector 60.

The base 10 is configured for mounting and fixing the doorbell 200. The base 10 may be installed on a wall (not shown) or a door (not shown) by threaded connection, adhesive connection, riveting, snap-fitting connection, or the like.

In this embodiment, the base 10 comprises a backplane 11 and a shell 12, the backplane 11 is arranged on the shell 12 to form a cavity (not shown) for providing enough space for the internal circuits (not shown).

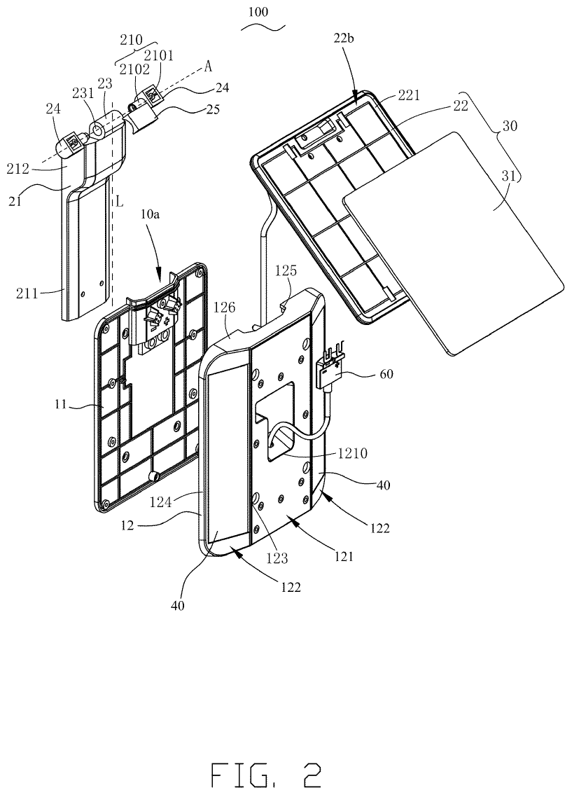

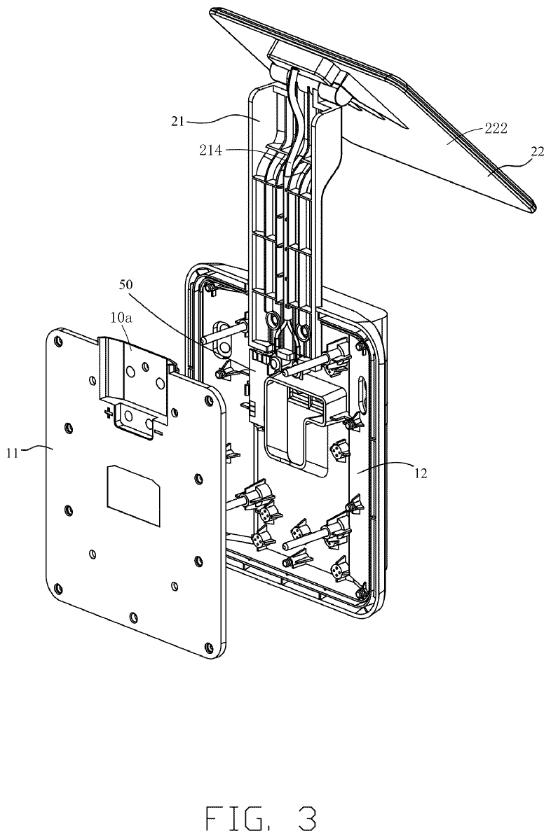

Referring to FIG. 2 and FIG. 3, the backplane 11 is substantially rectangular and arranged on the wall or the door. An end of the backplane 11 adjacent to the adjustment structure 20 includes a mounting portion 10a configured for mounting the adjustment structure 20. In this embodiment, the mounting portion 10a is a groove defined on the backplane 11.

The shell 12 is configured for installing the doorbell 200. Specifically, a surface of the shell 12 away from the backplane 11 includes a first mounting area 121 and at least one second mounting area 122, the first mounting area 121 is configured for mounting the doorbell 200, and an accommodating cavity 1210 is defined on the first mounting area 121 and configured for accommodating the electric connector 60 and a portion of charging connecting wires.

The at least one second mounting area 122 can be for example an approximately rectangular area and is configured for mounting a second solar panel 40, the second solar panel 40 is the same as or different from the first solar panel 31. The at least one second mounting area 122 is arranged obliquely to the first mounting area 121.

In this embodiment, the shell 12 includes two second mounting areas 122 located on both sides of the first mounting area 121. Each of the two second mounting areas 122 includes a first edge 123 and a second edge 124 arranged opposite to the first edge 123, the first edge 123 and the second edge 124 each serve as two long sides of the second mounting area 122. The first edge 123 is closer to the first mounting area 121 than the second edge 124, and the distance between the second mounting area 122 and the backplane 11 decreases along a direction from the first edge 123 to the second edge 124.

Because the two second mounting areas 122 are symmetrically disposed and arranged obliquely to the first mounting area 121, the second solar panel 40 on the left of the first mounting area 121 and the second solar panel 40 on right of the first mounting area 121 are symmetrically disposed, which can ensure that no matter whether the sun irradiates the solar charging apparatus 100 from the left or right, one second solar panel 40 can always receive sunlight, so that sufficient sunlight can be received, thereby obtaining sufficient electric energy. In addition, the structure of the solar charging apparatus 100 can be simplified.

In addition, a notch 125 corresponding to the mounting portion 10a is defined on an upper wall 126 of the shell 12, so that when the adjustment structure 20 is mounted on the mounting portion 10a, the adjustment structure 20 will not protrude from a back surface of the backplane 11.

The adjustment structure 20 includes a connecting member 21 and a matching member 24, the matching member 24 is rotatably connected to the connecting member 21 and capable of rotating around the rotation axis A. In this embodiment, the rotation axis A is perpendicular to a length direction L of the connecting member 21 and parallel to a width direction of the base 10.

One of the connecting member 21 and the matching member 24 is disposed on the base 10, and another one of the connecting member 21 and the matching member 24 is disposed on the solar panel assembly 30. In this embodiment, the connecting member 21 is arranged on the base 10, and the matching member 24 is arranged on the solar panel assembly 30.

One of the connecting member 21 and the matching member 24 comprises a connecting portion 210, another one of the connecting member 21 and the matching member 24 comprises an accommodation portion 23, and the connecting portion 210 is rotatably accommodated in the accommodation portion 23, the matching member 24 is rotatably connected to the connecting member 21 via the accommodation portion 23 and the connecting portion 210.

In this embodiment, the connecting member 21 comprises an accommodation portion 23, and the matching member 24 comprises a connecting portion 210.

Specifically, in this embodiment, the accommodation portion 23 comprises an insertion hole 231 passing through the accommodation portion 23. The connecting portion 210 comprises a pair of rotating portions 2101 arranged on the solar panel assembly 30, each of the pair of rotating portions 2101 comprises a shaft 2102, the shafts 2102 of the pair of the rotating portions 2101 are respectively rotatably inserted into two ends of the insertion hole 231, so that the connecting member 21 is rotatably connected to the matching member 24, and the solar panel assembly 30 can rotate relative to the base 10.

In this embodiment, the adjustment structure 20 further comprises a damping member 25, the damping member 25 is mounted on the solar panel assembly 30 and configured for abutting against the accommodation portion 23. The damping member 25 may be a plastic member or a rubber member.

The damping member 25 can stabilize the movement of the matching member 24 and the connecting member 21, thereby improving the stability and reliability of the solar panel assembly 30 during the rotation. In addition, by setting damping member 25, the rotation effect can be increased, and the rotational feel can be improved. In some embodiments, the supporting function of the damping member 25 can be achieved by gear or spherical universal wheel technology, which is not limited here.

The connecting member 21 comprises a first connected end 211 and a second connected end 212 arranged opposite to the first connected end 211. The first connected end 211 is coupled to the base 10, the second connected end 212 is rotatably connected to the matching member 24.

In addition, a thickness of the second end 212 is greater than a thickness of the first end 211, so as to provide a sufficient space for the rotation of the matching member 24. In addition, due to the sufficient thickness of the second end 212, when in folded state, the solar panel assembly 30 can be kept parallel to the wall or the length direction L of the connecting member 21 to improve aesthetics of the doorbell device 300.

The solar panel assembly 30 comprises a first solar panel 31 and a mounting member 22, the first solar panel 31 is configured for converting solar energy into electrical energy which is supplied to the doorbell 200. The mounting member 22 comprises a first surface 221 and a second surface 222 arranged opposite to the first surface 221, the first surface 221 is configured for mounting the first solar panel 31, and the second surface 222 is configured for mounting the adjustment structure 20. In this embodiment, the second surface 222 is configured for mounting the connecting portion 210.

In this embodiment, the first surface 221 of the mounting member 22 defines a receiving groove 22b, and the first solar panel 31 is fixedly received in the receiving groove 22b. The first solar panel 31 can be detachably arranged on the receiving groove 22b by adhesive, threaded connection, plug-in connection, clamping connection, pressing connection, etc., which is not limited herein.

A groove profile of the receiving groove 22b is adapted to a profile of the first solar panel 31, so that the first solar panel 31 can be closely connected to the mounting member 22.

In addition, in this embodiment, a width of the first solar panel 31 is substantially equal to the width of the base 10, in this way, the area of the first solar panel 31 can be maximized through a small solar charging apparatus 100.

In this embodiment, there is no interference between the first solar panel 31 and the doorbell 200, and the area of the first solar panel 31 is relatively large, which is not affected by the direction of sunlight. That is, regardless of whether the sunlight is radiating from the left or right, the first solar panel 31 can receive sufficient sunlight. In addition, the size of the first solar panel 31 is not limited by the presence of the doorbell 200, and there is enough space for the upper, lower, left and right sides of the first solar panel 31 to extend according to requirements, so as to increase the area of the first solar panel 31, thereby achieving an increase in power and meeting the power requirements of various doorbells.

In the other embodiment, there is no receiving groove 22b on the first surface 221 of the mounting member 22, and the first solar panel 31 is directly arranged on the first surface 221 of the mounting member 22, which is not limited herein.

In addition, a fixing portion 223 is arranged on the second surface 222 of the mounting member 22, The fixing portion 223 includes two first containing portions 224 and a second containing portion 22a located between the two first containing portions 224. Each of the two first containing portions 224 is configured to receiving the corresponding rotating portion 2101, and the second containing portion 22a is configured for receiving the damping member 25 of the adjustment structure 20. Specifically, the damping member 25 is mounted in the second containing portion 22a of the mounting member 22, so as to prevent the damping member 25 from moving during rotation.

In addition, the mounting member 22 further comprises an abutting portion 225, the abutting portion 225 on the second surface 222 of the mounting member 22 and configured for setting a position of the solar panel assembly 30 relative to the connecting member 21, so that when the solar charging apparatus 100 is in the folded state, the he first solar panel 31 is flushed with the door or the base. As a result, the packaging for product transportation can be minimized, saving packaging materials and shipping costs.

In some embodiments, the abutting portion 225 may be other structure arranged on the connecting member.

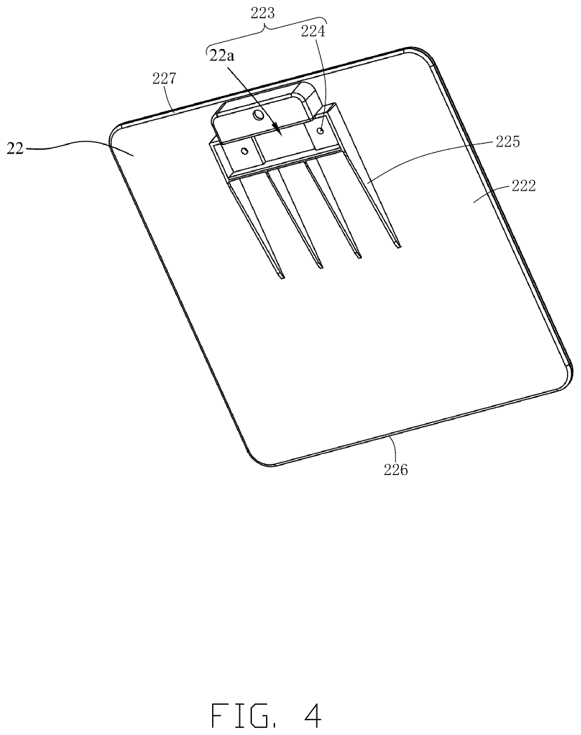

Referring to FIG. 4, the mounting member 22 includes a first side 226 and a second side 227 arranged opposite to the first side 226, and the first side 226 is closer to the doorbell 200 than the second side 227 when the doorbell device 200 is in the folded state. When the first solar panel 31 is rotated to be perpendicular to the length direction L of the connecting member 21, the second side 227 abuts the wall. In some embodiment, when the first solar panel 31 is rotated to be perpendicular to the length direction L of the connecting member 21, there is a gap between the second side 227 and the wall.

In addition, electric wires 214 are received a cavity behind the connecting member 21, the cavity is configured for hiding the electric wires 214, so that it is difficult for users to see the electric wires 214 on an appearance, and the appearance of the solar charging apparatus 100 can be beautified.

The circuit board 50 is configured for managing the power supply situation of the first solar panel 31 and/or the second solar panel 40. The first solar panel 31 and/or the second solar panel 40 are electrically connected to the circuit board 50. The circuit board 50 may be arranged in the base 10, may also be arranged on the adjustment structure 20, and may also be arranged independently, which is not limited herein. In this embodiment, the circuit board 50 and most of charging connecting wires are housed in a cavity formed by the backplane 11 and the shell 12.

In some embodiment, the circuit board 50 can be omitted, which is not limited herein.

The electric connector 60 is configured for supplying generated electric energy to the doorbell 200. A connection interface of the electric connector 60 may be adjusted according to a specific connection structure. For example, the connection interface of the electric connector 60 may be a USB connector, a type-c connector, a light connector.

One end of the electric connector 60 is connected to the circuit board 50, and another end is connected to the doorbell 200.

According to the doorbell device 300 provided by the present disclosure, the first solar panel 31 is capable of rotating relative to the connecting member 21, so that the user can control the first solar panel 31 to rotate an optimal angle according to the orientation of the season, the orientation of the house, the user's experience. As a result, the first solar panel 31 remains in an optimal orientation, so as to receive sunlight to the maximum extent possible and improve light conversion efficiency. In addition, the solar panel is close to the doorbell, and is convenient for wiping dust or/and dirt on the first solar panel 31, thereby preventing dust or/and dirt from being deposited on the surface of the solar panel, which results in a decrease in the efficiency of the solar panel.

### Second Embodiment

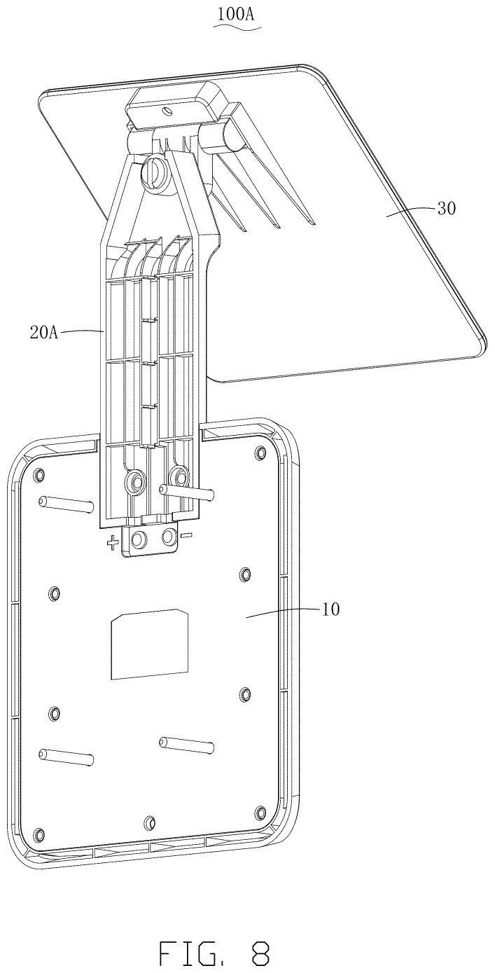

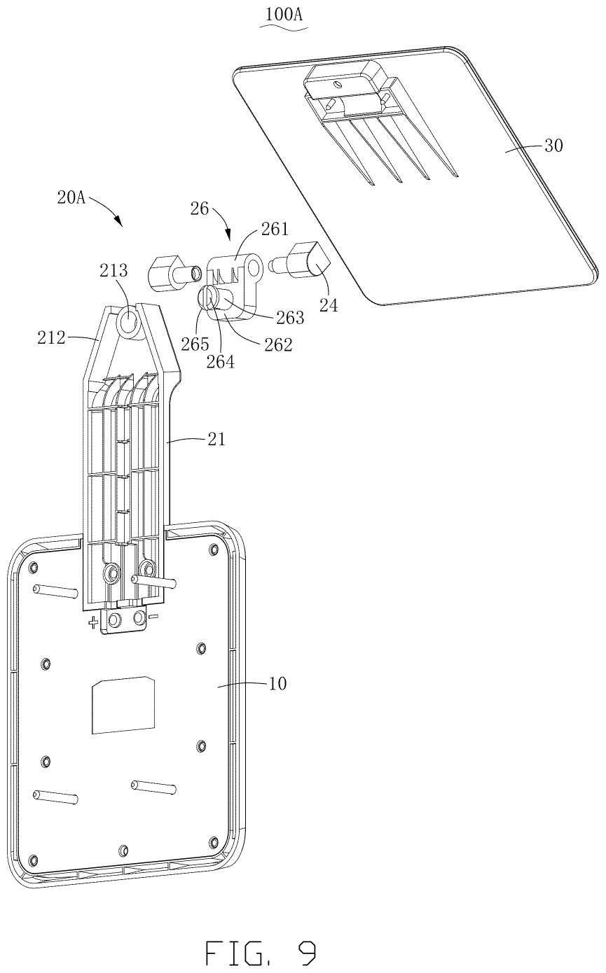

Based on FIGS. 8 to 9, the second embodiment of the present disclosure is explained below. In addition, for the convenience of explanation, the components with the same functions as those described in the above embodiments are labeled with the same reference numerals, and their explanations are omitted.

Referring to FIGS. 8 to 9, the difference between the solar charging apparatus 100A of this embodiment and the solar charging apparatus 100 of the first embodiment is that the structure of the adjustment structure 20A is different, and the other components are the same as those in the first embodiment and will not be repeated here.

In this embodiment, the adjustment structure 20A further comprises a pivot element 26, the pivot element 26 comprises a first end 261 and a second end 262 arranged opposite to the first end 261, the first end 261 of the pivot element 26 is rotatably connected to the matching member 24, and the second end 262 is rotatably connected to the connecting member 21, that the connecting member 21 is rotatably connected to the matching member 24 by the pivot element 26.

A through-hole 213 is defined on the second connected end 212 of the connecting member 21, the pivot element 26 comprises an extension portion 263, the extension portion 263 protrudes from a surface of the second end 262 facing the connecting member 21 and inserted into the through-hole 213, so that the connecting member 21 is rotatably engaged with the matching member 24.

In this way, the user can rotate the first solar panel 31 to an optimal angle and an optimal position according to the orientation of the season, the orientation of the house and the user's experience.

In addition, a clamping portion 264 is disposed on an end of the extension portion 263. When the extension portion 263 is inserted into the through-hole 213, the clamping portion 264 is pressed against the circumference of the through-hole 213 to prevent pivot element 26 from detaching from the connecting member 21.

In addition, a fillister 265 is defined on the clamping portion 264. When inserting the extension portion 263 into the through-hole 213, due to a presence of the fillister 265, the extension portion 263 can be squeezed to allow it to be inserted into through-hole 213.

The connection structure between the first end 261 and the matching member 24 is the same as the connection structure between the connecting member 21 and the matching member 24 in the first embodiment and will not be repeated here.

### Third Embodiment

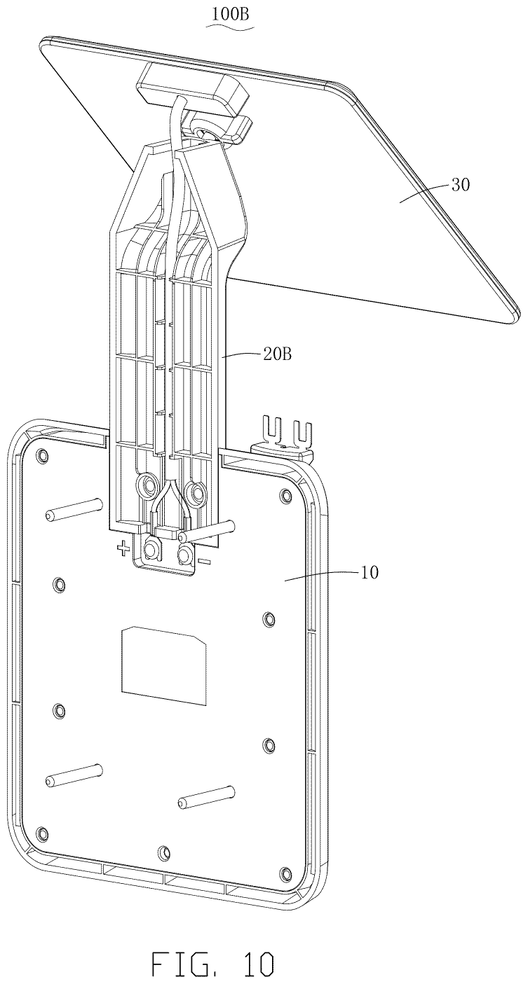

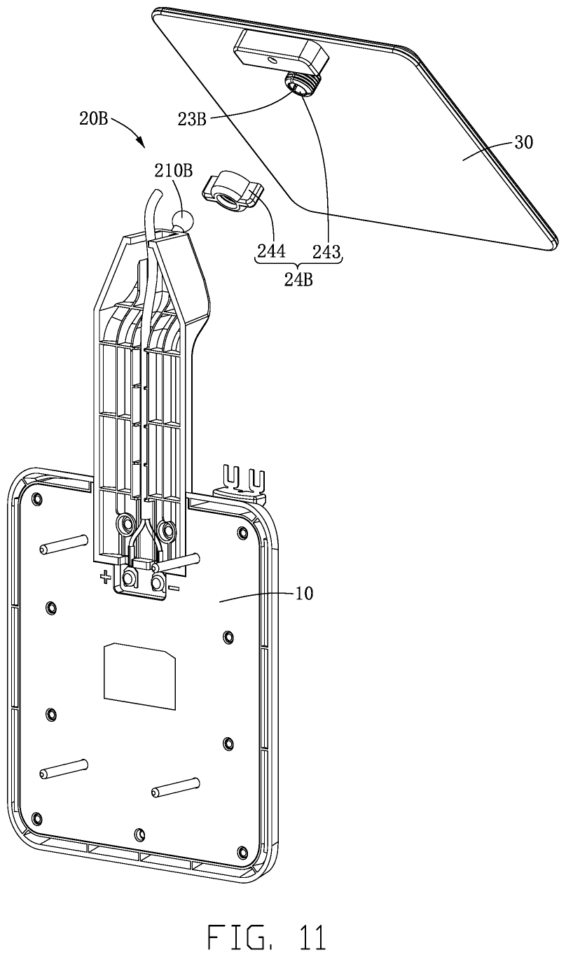

Based on FIGS. 10 to 11, the third embodiment of the present disclosure is explained below. In addition, for the convenience of explanation, the components with the same functions as those described in the above embodiments are labeled with the same reference numerals, and their explanations are omitted.

Referring to FIGS. 10 to 11, the difference between the solar charging apparatus 100B of this embodiment and the solar charging apparatus 100 of the first embodiment is that the structure of the adjustment structure 20B is different, and the other components are the same as those in the first embodiment and will not be repeated here.

In this embodiment, the connecting portion 210B is arranged on the connecting member 21, and connecting portion 210 comprises a spherical shape, and the accommodation portion 23B matches a contour of the connecting portion 210B, so that the connecting portion 210B is rotatably received in the accommodation portion 23B.

The matching member 24B comprises a claw 243 and a fixing member 244, the claw 243 arranged on the solar panel assembly 30, the accommodation portion 23B is defined in the claw 243. The fixing member 244 sleeved on the claw 243 and configured for fixedly accommodating the connecting portion 210B in the accommodation portion 23. In this embodiment, the fixing member 244 is thready connected to the claw 243.

In this way, the user can rotate the first solar panel 31 to an optimal angle according to the orientation of the season, the orientation of the house and the user's experience.

In this embodiment, the connecting portion 210B is tightened and loosened by the fixing member 244, and the reasonable friction effect is achieved by squeezing, thereby improving the user's feel when rotating.

In addition, the claw 243 is composed of three components spaced from each, so that the connecting portion 210B can be inserted into the accommodation portion 23B.

In addition, the claw 243 and the mounting member 22 are integrally formed. In some embodiments, the claw 243 can be detachably arranged on the mounting member 22, which is not limited herein.

### Fourth Embodiment

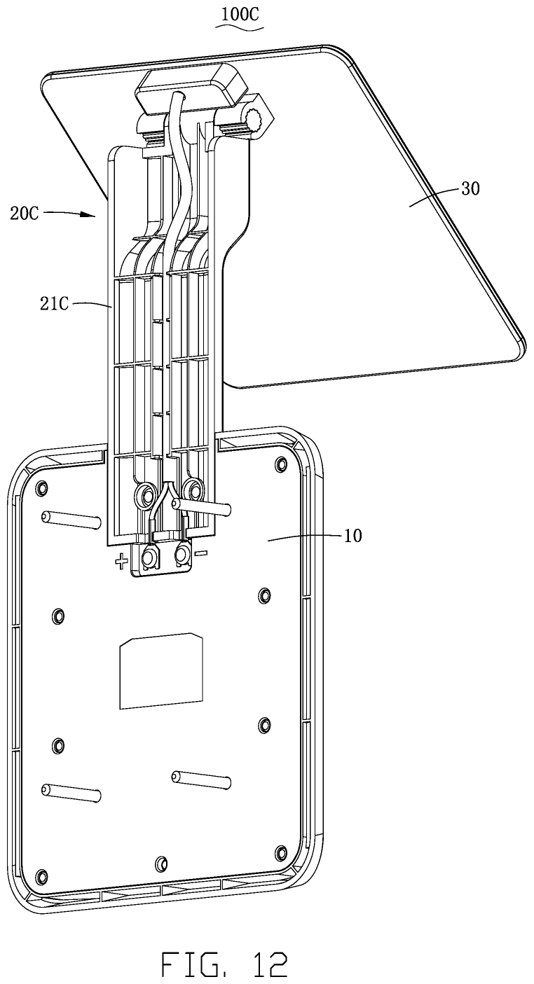

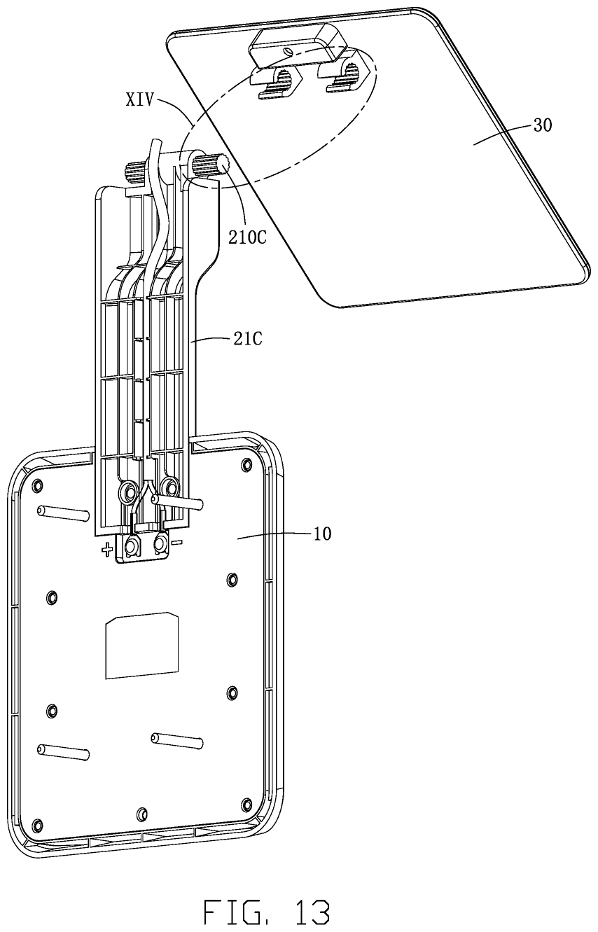

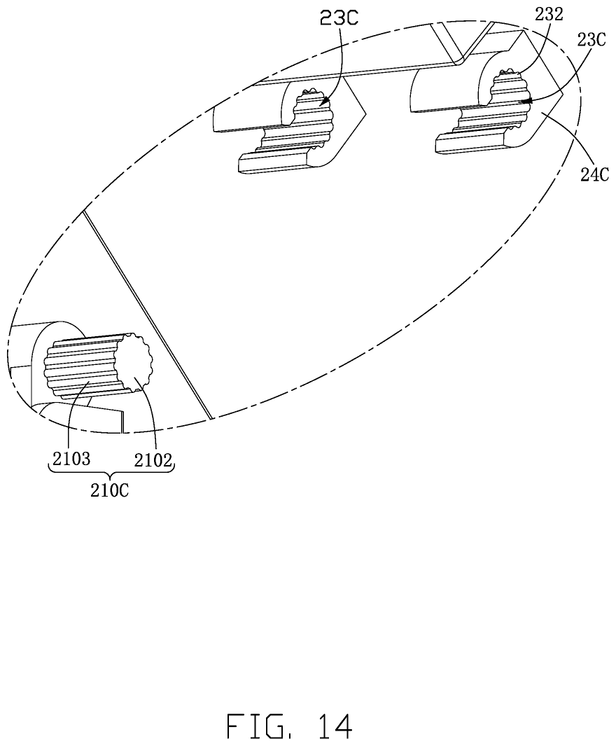

Based on FIGS. 12 to 14, the fourth embodiment of the present disclosure is explained below. In addition, for the convenience of explanation, the components with the same functions as those described in the above embodiments are labeled with the same reference numerals, and their explanations are omitted.

Referring to FIGS. 12 to 14, the difference between the solar charging apparatus 100C of this embodiment and the solar charging apparatus 100 of the first embodiment is that the structure of the adjustment structure 20C is different, and the other components are the same as those in the first embodiment and will not be repeated here.

In this embodiment, the connecting portion 210C is arranged on the connecting member 21, and the connecting portion 210C comprises at least one shaft 2102 arranged at one end of the connecting member 21C, and the at least one shaft 2102 extends along a width direction of the connecting member 21C. The matching member 24C is arranged on the solar panel assembly 30, and the accommodation portion 23C comprises a shape that matches the shape of the at least one shaft 2102, and the at least one shaft 2102 is rotatably accommodated in the accommodation portion 23C.

In this embodiment, the connecting portion 210C comprises a pair of shafts 2102, and the matching member 24C comprises a pair of the accommodation portions 23C, each of the pair of shafts 2102 is rotatably received in the corresponding accommodation portion 23C.

In addition, a plurality of ribs 2103 are spaced from each other and arranged on a circumferential wall of the shaft 2102, the plurality of ribs 2103 extend along an extending direction of the shaft 2102, a plurality of concaves 232 are spaced from each other and arranged on an inner wall of the accommodation portion 23C, each of the plurality of ribs 2103 is respectively engaged with a corresponding one of the plurality of concaves 232, so that the matching member 24 is rotatably connected to the connecting member 21 and positioned above the connecting member 21.

In addition, the matching member 24C are formed on solar panel assembly 30 by injection molding.

### Fifth Embodiment

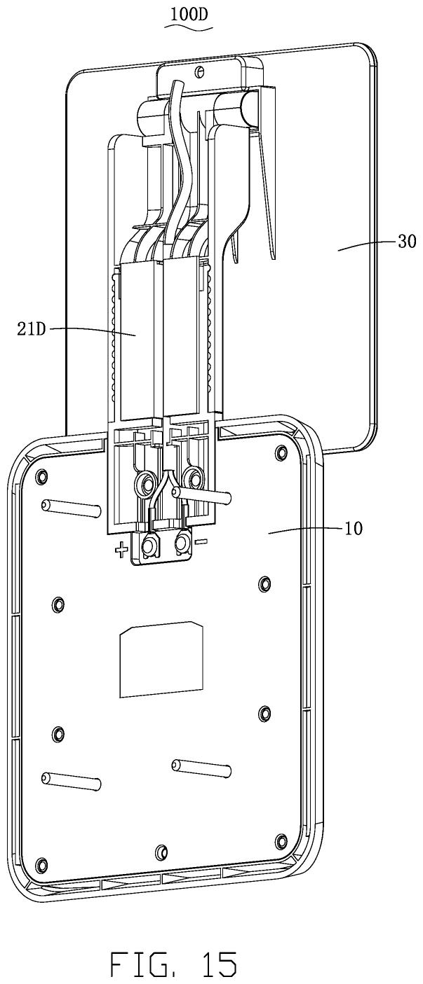

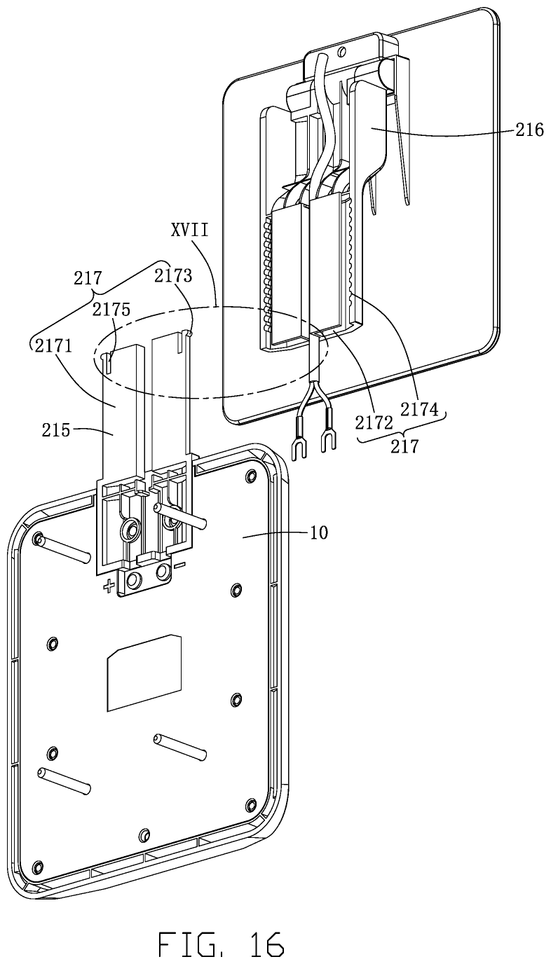

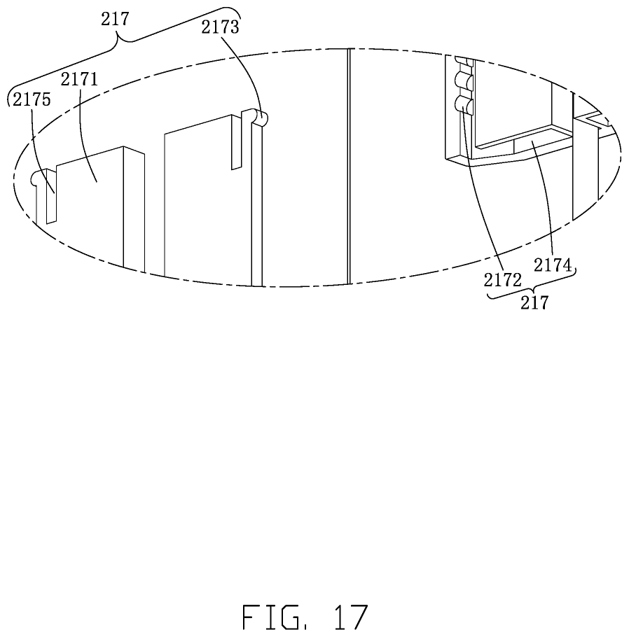

Based on FIGS. 15 to 17, the fifth embodiment of the present disclosure is explained below. In addition, for the convenience of explanation, the components with the same functions as those described in the above embodiments are labeled with the same reference numerals, and their explanations are omitted.

Referring to FIGS. 15 to 17, the difference between the solar charging apparatus 100D of this embodiment and the solar charging apparatus 100 of the first embodiment is that the structure of the connecting member 21D is different, and the other components are the same as those in the first embodiment and will not be repeated here. In this embodiment, the connecting member 21D comprises a first connecting member 215, a second connecting member 216 and a sliding member 217, one end of the first connecting member 215 is arranged on the base 10, and another end of the first connecting member 215 is slidably connected to the second connecting member 216 by the sliding member 217.

The sliding member 217 comprises at least one connection rod 2171 and at least one slideway 2172, the at least one connection rod 2171 is slidably received in the at least one slideway 2172 and fixed by a snap (not show).

In this way, the length of the connecting member 21D can be adjusted according to demand, thereby adjusting the height of the first solar panel 31.

In this embodiment, the first connecting member 21D comprises a pair of connection rods 2171, a protrusion 2173 is arranged on the side wall of each of the pair of connection rod 2171.

A pair of slideways 2172 are defined on the second connecting member 21D and configured for received the corresponding connection rod 2171. In addition, a plurality of positioning belt 2174 is formed on an inner wall surrounding the pair of slideways 2172 and configured for abutting the protrusion 2173, so as to achieve positioning between the first connecting member 2171 and the second connecting member 2172.

In addition, a recess 2175 is defined on each of the pair of connection rods 2171, the recess 2175 is defined on a side near the protrusion 2173, so as to enable the first connecting member 215 slidably connected to the second connecting member 216.

### Sixth Embodiment

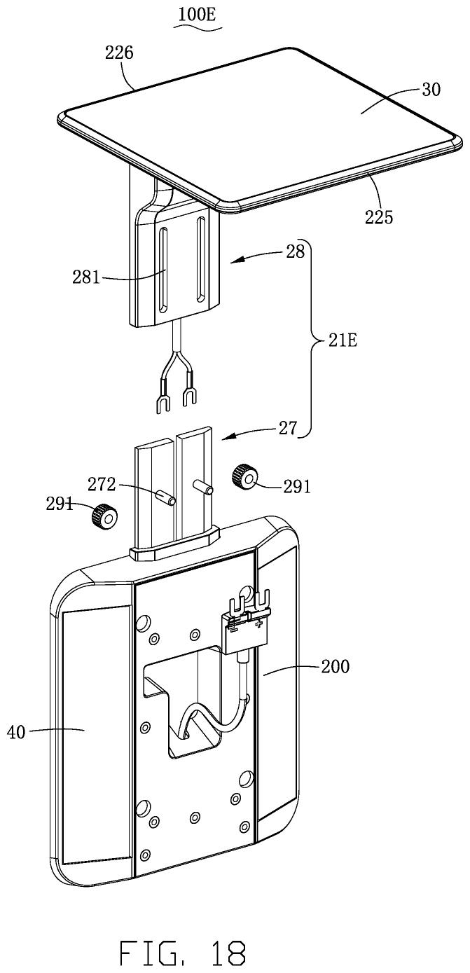

Based on FIG. 18, the sixth embodiment of the present disclosure is explained below. In addition, for the convenience of explanation, the components with the same functions as those described in the above embodiments are labeled with the same reference numerals, and their explanations are omitted.

Referring to FIG. 18, the difference between the solar charging apparatus 100E of this embodiment and the solar charging apparatus 100 of the first embodiment is that the structure of the connecting member 21E is different, and the other components are the same as those in the first embodiment and will not be repeated here.

In this embodiment, the connecting member 21E further comprises a first connecting member 27, a second connecting member 28 and a sliding member, one end of the first connecting member 27 is arranged on the base 10, and another end of the first connecting member 27 is slidably connected to the second connecting member 28 by the sliding member.

The sliding member includes a lock member 291, an installed portion 272, and an insertion portion 281, the installed portion 272 protrudes from a surface of the first connecting member 27, and the insertion portion 281 is defined on the second connecting member 28, the installed portion 272 passes the insertion portion 281 and locks by the locking member 291.

In this way, when rotating the locking member 291 in a first direction, the connection between the first connecting member 27 and the second connecting member 28 can be locked. When rotating the locking member 291 in a second direction opposite to the first direction, the second connecting member 28 can slide relative to the first connecting member 27.

In this embodiment, the installed portion 272 includes a pair of fixed pins, the insertion portion 281 includes a pair of slots.

In this way, the height of the connecting member 21E can be adjusted by the sliding member according to requirements, and the light receiving area of the first solar panel 31 can be further increased.

### Seventh Embodiment

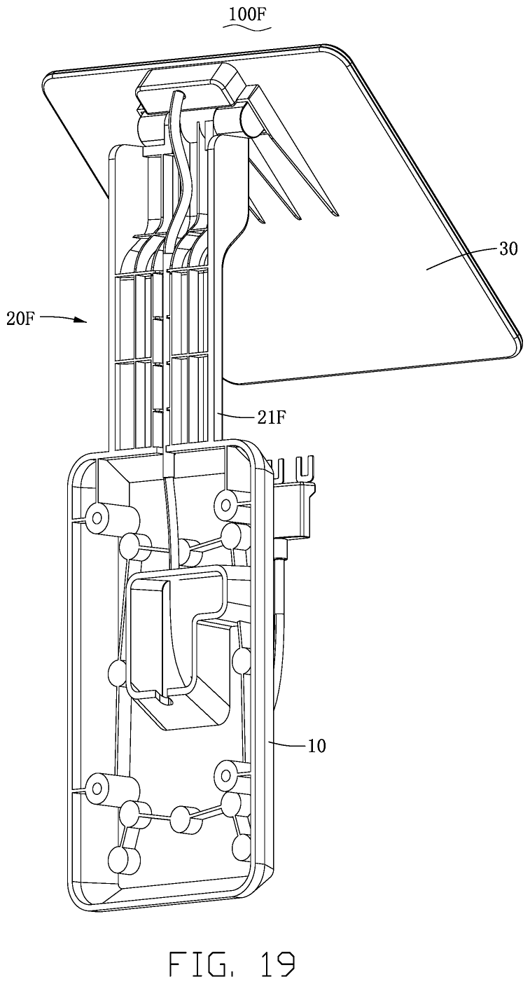

Based on FIG. 19, the seventh embodiment of the present disclosure is explained below. In addition, for the convenience of explanation, the components with the same functions as those described in the above embodiments are labeled with the same reference numerals, and their explanations are omitted.

Referring to FIG. 19, the difference between the solar charging apparatus 100F of this embodiment and the solar charging apparatus 100 of the first embodiment is that the structure of the adjustment structure 20F is different, and the other components are the same as those in the first embodiment and will not be repeated here. In this embodiment, the connecting member 21F and the base 10 are integrally formed, so as to simplify the structure of the solar charging apparatus.

In addition, in this embodiment, the backplane 11 is omitted, that is the solar charging apparatus is fixed on the wall or the door only by the shell 12, so as to simplify the structure of the solar charging apparatus.

### Eighth Embodiment

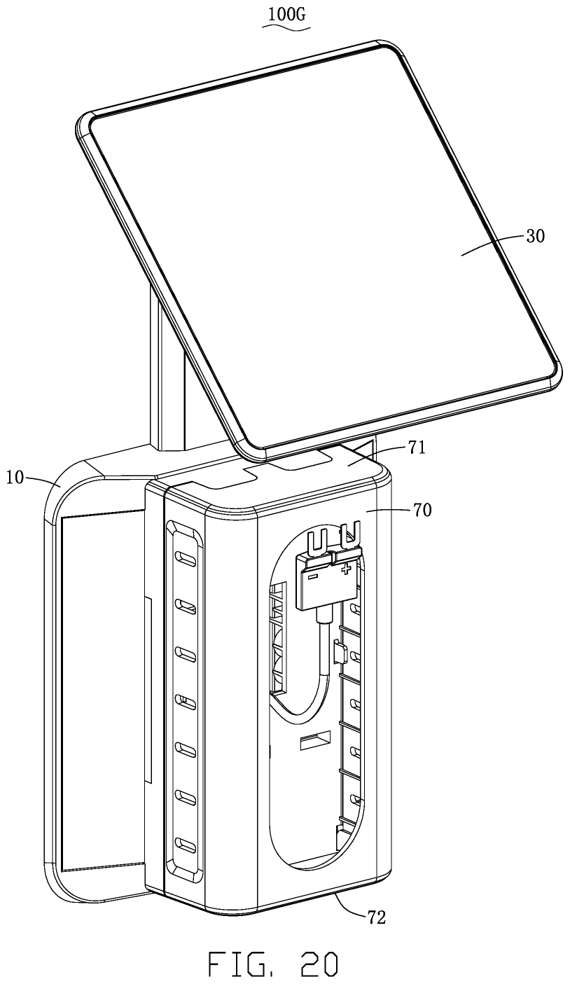

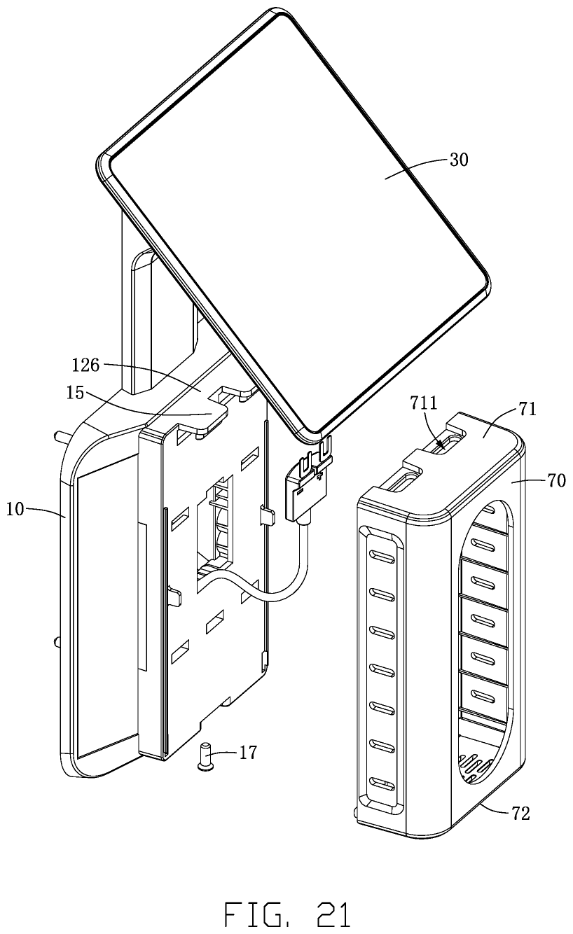

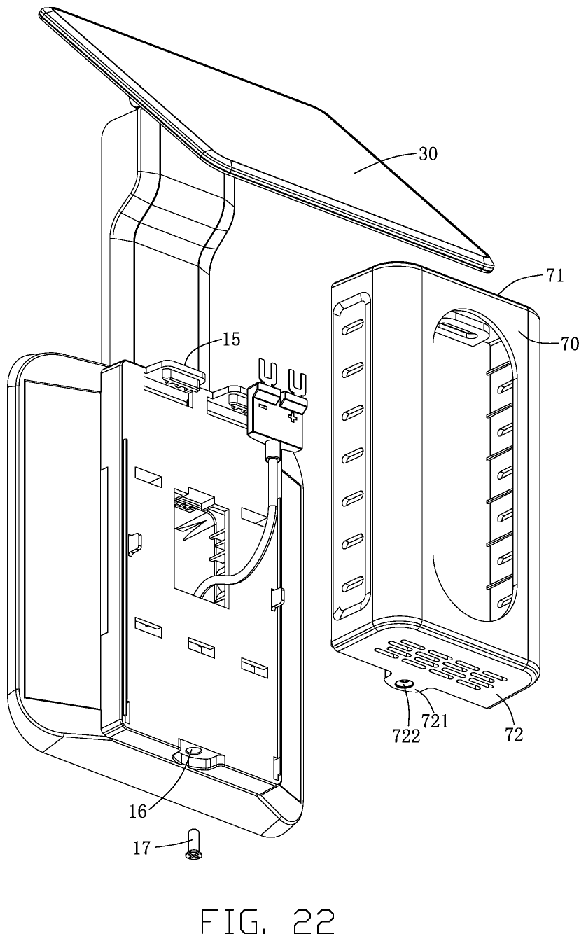

Based on FIGS. 20 to 22, the second embodiment of the present disclosure is explained below. In addition, for the convenience of explanation, the components with the same functions as those described in the above embodiments are labeled with the same reference numerals, and their explanations are omitted.

Referring to FIGS. 20 to 22, the difference between the solar charging apparatus 100G of this embodiment and the solar charging apparatus 100 of the first embodiment is that the manner for mounting the doorbell 200 on the solar charging apparatus 100G is different, and the other components are the same as those in the first embodiment and will not be repeated here.

In this embodiment, the solar charging apparatus 100G further comprises a cover 70 arranged on the base 10, the cover 70 and the base 10 form an accommodating cavity configured for accommodating the doorbell 200.

In this embodiment, the cover 70 is detachably arranged on the base 10. Specifically, the cover 70 comprises a top wall 71 and a bottom wall 72 arranged opposite to the top wall 71. At least one positioning hole 711 is defined on the top wall 71 and pass through the top wall 71, the base 10 further comprises at least one positioning member 15 arranged on an edge of the upper wall 126 of the base 10, the at least one positioning member 15 is embedded in the at least one positioning hole 711. In this embodiment, the cover 70 comprises a pair of the positioning holes 711, and the base 10 comprises a pair of the positioning members 15, each of the pair of the positioning members 15 is embedded in the corresponding positioning hole 711.

In addition, an edge of the bottom wall 72 of the cover 70 is provide with a lock portion 721, a first lock hole 722 is defined on the lock portion 721, and a second lock hole 16 is defined on a bottom wall of the base 10, a fastener 17 passes through the first lock hole 722 and the second lock hole 16 in sequence, thereby securing the connection between the cover 70 and the base 10.

In this embodiment, the fastener 17 is a screw, and both of the first lock hole 722 and the second lock hole 16 are threaded holes.

According to the above structure, this embodiment can achieve the same effect as the first embodiment. In addition, by arranging the cover 70 on the base 10, the doorbell 200 can be protected by this cover 70.

In addition, ordinary technical personnel in this field should recognize that the above embodiments are only configured to illustrate the present application and not as a limitation of the present application. As long as they are within the substantive scope of the present application, any appropriate changes and changes made to the above embodiments fall within the scope of the disclosure of the present application.

What is claimed is:

1. A solar charging apparatus configured for a doorbell device comprising:
a base configured for mounting and fixing a doorbell;
a solar panel assembly; and
an adjustment structure, wherein:
the solar panel is rotatably connected to the base by the adjustment structure,
the solar panel assembly comprises a first solar panel configured for converting solar energy into electrical energy which is supplied to the doorbell, and
the adjustment structure is configured for adjusting an angle of the first solar panel relative to the base, so as to switch the solar charging apparatus between a folded state and an unfolded state.

2. The solar charging apparatus according to claim 1, wherein the adjustment structure comprises a connecting member and a matching member, the matching member is rotatably connected to the connecting member,
one of the connecting member and the matching member is disposed on the base, and another one of the connecting member and the matching member is disposed on the solar panel assembly.

3. The solar charging apparatus according to claim 2, wherein one of the connecting member and the matching member comprises a connecting portion, another one of the connecting member and the matching member comprises an accommodation portion, and the connecting portion is rotatably accommodated in the accommodation portion, the matching member is rotatably connected to the connecting member via the accommodation portion and the connecting portion.

4. The solar charging apparatus according to claim 3, wherein the connecting portion comprises a shaft arranged at one end of the connecting member along a width direction of the connecting member, a shape of the accommodation portion matches a shape of the shaft, and the shaft is rotatably accommodated in the accommodation portion.

5. The solar charging apparatus according to claim 4, further comprising a plurality of ribs spaced from each other and arranged on a circumferential wall of the shaft, the plurality of rib extending along an extending direction of the shaft; and
a plurality of concaves spaced from each other and arranged on an inner wall of the accommodation portion, wherein
each of the plurality of ribs is respectively engaged with a corresponding one of the plurality of concaves, so that the matching member is rotatably connected to the connecting member and positioned above the connecting member.

6. The solar charging apparatus according to claim 3, wherein the connecting portion comprises a spherical shape, and a shape of the accommodation portion matches a contour of the connecting portion, so that the connecting portion is rotatably received in the accommodation portion.

7. The solar charging apparatus according to claim 6, wherein
the matching member comprises:
a claw arranged on the solar panel assembly, the accommodation portion is defined in the claw; and
a fixing member sleeved on the claw and configured for fixedly accommodating the connecting portion in the accommodation portion.

8. The solar charging apparatus according to claim 2, wherein the connecting member is arranged on the base,
the adjustment structure comprises a pivot element, the pivot element comprises a first end and a second end arranged opposite to the first end, the first end is rotatably connected to the matching member, and the second end is rotatably connected to the connecting member, so that the connecting member is rotatably connected to the matching member by the pivot element.

9. The solar charging apparatus according to claim 8, wherein an end of the connecting member away from the base is provided with a through-hole, the pivot element comprises an extension portion, the extension portion protrudes from a surface of the second end facing the connecting member and is inserted into the through-hole, so that the connecting member is rotatably engaged with the connecting member.

10. The solar charging apparatus according to claim 2, wherein the connecting member comprises a first connecting member, a second connecting member and a sliding member, one end of the first connecting member is arranged on the base, and another end of the first connecting member is slidably connected to the second connecting member by the sliding member.

11. The solar charging apparatus according to claim 2, wherein the connecting member and the base are integrally formed.

12. The solar charging apparatus according to claim 2, wherein
the connecting member is arranged on the base, the solar charging apparatus further comprising an abutting portion on an end of the connecting member away from the base or on a back surface of the solar panel assembly, and the abutting portion is configured for setting a position of the solar panel assembly relative to the connecting member so that, when the solar charging apparatus is in the folded state, the first solar panel is flushed with the base.

13. The solar charging apparatus according to claim 1, wherein the solar panel assembly further comprises a mounting member, the mounting member comprises a first surface and a second surface arranged opposite to the first surface, the first surface is configured for mounting the first solar panel, and the second surface is configured for mounting the adjustment structure.

14. The solar charging apparatus according to claim 13, wherein the first surface of the mounting member defines a receiving groove, and the first solar panel is fixedly received in the receiving groove.

15. The solar charging apparatus according to claim 1, wherein the base comprises a first mounting area configured for mounting the doorbell.

16. The solar charging apparatus according to claim 15, wherein the base further comprises at least a second mounting area disposed adjacent the first mounting area,
the solar charging apparatus further comprises at least one second solar panel mounted on the at least one second mounting area.

17. The solar charging apparatus of claim 16, wherein the at least one second mounting area is arranged obliquely to the first mounting area.

18. The solar charging apparatus according to claim 1, further comprising a cover arranged on the base, the cover and the base forming an accommodating cavity configured for accommodating the doorbell.

19. A solar charging apparatus configured for a doorbell device, comprising:
a base configured for mounting and fixing a doorbell;
a solar panel; and
an adjustment structure, wherein:
the solar panel is connected to the base by the adjustment structure,
the solar panel is configured for converting solar energy into electrical energy which is supplied to the doorbell, and
the adjustment structure is connected between the base and the solar panel and configured for adjusting an angle of the solar panel relative to the base.

20. A doorbell device comprising:
a doorbell;
a base configured for mounting and fixing the doorbell;
a solar panel assembly; and
an adjustment structure, wherein:
the solar panel assembly is rotatably connected to the base by the adjustment structure,
the solar panel assembly comprises a solar panel configured for converting solar energy into electrical energy which is supplied to the doorbell; and
the adjustment structure is configured for adjusting an angle of the solar panel relative to the base, so as to switch the solar panel assembly between a folded state and an unfolded state.
